(19) United States
(12) Patent Application Publication
(10) Pub. No.: US 2024/0004398 A1
(43) Pub. Date: Jan. 4, 2024

(54) CONTROL METHOD AND CONTROL DEVICE FOR PROVIDING GUIDANCE, CHARGING PILE AND ROBOT

(71) Applicant: JINGDONG TECHNOLOGY INFORMATION TECHNOLOGY CO., LTD., BEIJING (CN)

(72) Inventors: Xiujun YAO, BEIJING (CN); Chenguang GUI, BEIJING (CN); Zhetao XU, BEIJING (CN)

(21) Appl. No.: 18/253,561

(22) PCT Filed: Sep. 23, 2021
(86) PCT No.: PCT/CN2021/119826

§ 371 Date: May 18, 2023

(30) Foreign Application Priority Data
Dec. 14, 2020 (CN) 202011467074.8

(51) Int. Cl. G05D 1/02; B60L 53/66; B60L 53/36

(52) U.S. Cl. CPC G05D 1/0225; B60L 53/66; B60L 2240/62; G05D 2201/0207; B60L 53/36

(57) ABSTRACT

The present disclosure provides a control method and control device for providing guidance, a charging pile and a robot. The control method for providing guidance comprises: triggering a first positioning circuit to transmit a first request message at a preset period, and a second positioning circuit to transmit a second request message at the preset period after receiving a guidance request message transmitted by a robot; determining a first distance between the robot and the first positioning circuit; determining a second distance between the robot and the second positioning circuit; determining a position of the robot relative to the charging pile according to the first distance and the second distance; and transmitting information about the position to the robot, thereby the robot adjusting a path according to the position to complete the docking of the robot to the charging pile.

### CROSS-REFERENCE TO RELATED APPLICATIONS

The present disclosure is based on and claims priority from CN application No. 202011467074.8, filed on Dec. 14, 2020, the disclosure of hereby is incorporated herein by reference in its entirety.

### TECHNICAL FIELD

The disclosure relates to the field of control, in particular to a control method and a control device for providing guidance, a charging pile and a robot.

### BACKGROUND

The machine room inspection robot is an intelligent equipment for assisting or replacing manpower to execute inspection tasks in a data machine room. Because the machine room inspection robot has the characteristics of being intelligent, of low cost and capable of performing inspection incessantly, they are deployed in large quantities in a data machine room. During working, the inspection robot is powered by a battery, and when the battery level is below a preset threshold, the inspection robot will return to the charging pile automatically for charging.

### SUMMARY

According to a first aspect of the embodiments of the present disclosure, there is provided a control method for providing guidance performed by a control device for providing guidance in a charging pile, comprising: triggering a first positioning circuit to transmit a first request message at a preset period, and triggering a second positioning circuit to transmit a second request message at the preset period after receiving a guidance request message transmitted by a robot, thereby the robot transmitting a first response message after receiving the first request message, and transmitting a second response message after receiving the second request message; determining a first distance between the robot and the first positioning circuit according to a time delay between the first positioning circuit transmitting the first request message and receiving the first response message after the first positioning circuit receiving the first response message; determining a second distance between the robot and the second positioning circuit according to a time delay between the second positioning circuit transmitting the second request message and receiving the second response message after the second positioning circuit receiving the second response message; determining a position of the robot relative to the charging pile according to the first distance and the second distance; and transmitting information about the position to the robot, thereby the robot adjusting a path according to the position to complete the docking of the robot to the charging pile.

In some embodiments, the control method further comprising: detecting whether a signal receiver receive a signal transmitted by a signal transmitter, wherein the signal receiver cannot receive the signal transmitted by the signal transmitter under a condition that a charging electrode of the robot is in contact with a charging electrode of the charging pile; and triggering the first positioning circuit to stop transmitting the first request message, and triggering the second positioning circuit to stop transmitting the second request message under a condition that the signal receiver cannot receive the signal transmitted by the signal transmitter, and transmitting a guidance ending instruction to the robot.

In some embodiments, the determining a first distance between the robot and the first positioning circuit comprises: extracting a first transmitting time of the first positioning circuit for transmitting the first request message and a first receiving time of the first positioning circuit for receiving the first response message; and calculating the first distance according to the difference between the first receiving time and the first transmitting time.

In some embodiments, the determining a first distance between the robot and the first positioning circuit further comprises: extracting a second receiving time of the robot for receiving the first request message and a second transmitting time of the robot for transmitting the first response message from the first response message; wherein the calculating the first distance comprises: calculating a first difference between the first receiving time and the first transmitting time, and a second difference between the second transmitting time and the second receiving time; and calculating the first distance according to a difference between the first difference and the second difference.

In some embodiments, the determining a second distance between the robot and the second positioning circuit comprises: extracting a third transmitting time of the second positioning circuit for transmitting the second request message, and a third receiving time of the second positioning circuit for receiving the second response message; and calculating the second distance according to a difference between the third receiving time and the third transmitting time.

In some embodiments, the determining a second distance between the robot and the second positioning circuit further comprises: extracting a fourth receiving time of the robot for receiving the second request message and a fourth transmitting time of the robot for transmitting the second response message from the second response message; wherein the calculating the second distance comprises: calculating a third difference between the third receiving time and the third transmitting time, and a fourth difference between the fourth transmitting time and the fourth receiving time; and calculating the second distance according to a difference between the third difference and the fourth difference.

In some embodiments, the determining a position of the robot relative to the charging pile according to the first distance and the second distance comprises: determining a first circular trajectory by taking a position of the first positioning circuit as a circle center and the first distance as a radius; determining a second circular trajectory by taking a position of the second positioning circuit as a circle center and the second distance as a radius; and taking the intersection point of the first circular trajectory and the second circular trajectory as the position of the robot relative to the charging pile.

According to a second aspect of an embodiment of the present disclosure, there is provided a control device for providing guidance, comprising: a triggering module configured to trigger a first positioning circuit to transmit a first request message at a preset period, and trigger a second positioning circuit to transmit a second request message at the preset period after receiving a guidance request message transmitted by a robot, thereby the robot transmitting a first response message after receiving the first request message, and transmitting a second response message after receiving the second request message; a first distance determining module configured to determine a first distance between the robot and the first positioning circuit according to a time delay between the first positioning circuit transmitting the first request message and receiving the first response message after the first positioning circuit receiving the first response message; a second distance determining module configured to determine a second distance between the robot and the second positioning circuit according to a time delay between the second positioning circuit transmitting the second request message and receiving the second response message after the second positioning circuit receiving the second response message; a position determining module configured to determine a position of the robot relative to the charging pile according to the first distance and the second distance; and a guiding module configured to transmit information about the position to the robot, thereby the robot adjusting a path according to the position to complete the docking of the robot to the charging pile.

According to a third aspect of the embodiments of the present disclosure, there is provided a control device for providing guidance, comprising: a processor; and a memory coupled to the processor, storing program instructions which, when executed by the processor, cause the processor to implement the control method according to any one of the embodiments described above.

According to a fourth aspect of the embodiments of the present disclosure, there is provided a charging pile, comprising: the control device for providing guidance according to anyone of the embodiments described above; a first communicating circuit configured to transmit a guidance request transmitted by a robot to the control device for providing guidance and transmit information about a position determined by the control device for providing guidance to the robot; a first positioning circuit configured to transmit a first request message at a preset period according to a trigger instruction transmitted by the control device for providing guidance and receive a first response message transmitted by the robot upon receiving the first request message; and a second positioning circuit configured to transmit a second request message at a preset period according to a trigger instruction transmitted by the control device for providing guidance, and receive the second response message transmitted by the robot upon receiving the second request message.

In some embodiments, further comprising: a signal transmitter; a signal receiver configured to receive a signal transmitted by the signal transmitter, wherein the signal receiver cannot receive the signal transmitted by the signal transmitter under a condition that a charging electrode of the robot is in contact with a charging electrode of the charging pile.

In some embodiments, the first communicating circuit is further configured to transmit a guidance ending instruction transmitted by the guidance control device to the robot; the first positioning circuit is further configured to stop transmitting the first request message according to a trigger instruction transmitted by the control device for providing guidance; and the second positioning circuit is further configured to stop transmitting the second request message according to a trigger instruction transmitted by the control device for providing guidance.

According to a fifth aspect of an embodiment of the present disclosure, there is provided a control method for providing guidance performed by a robot control device, comprising: detecting whether the robot is currently in a preset guidance area in the process of approaching a charging pile; entering a guidance mode under a condition that the robot is currently in the preset guidance area; transmitting a guidance request message to the charging pile, thereby a third positioning circuit transmitting a first response message to the charging pile after receiving a first request transmitted by the charging pile, and transmitting a second response message to the charging pile after receiving a second request transmitted by the charging pile; adjusting a path according to a position after receiving information about the position transmitted by the charging pile; and driving a moving mechanism according to the path, thereby the robot docking to the charging pile.

In some embodiments, the first response message comprises a time of the third positioning circuit for receiving the first request message and a time of the third positioning circuit for transmitting the first response message; and the second response message comprises a time of the third positioning circuit for receiving the second request message and a time of the third positioning circuit for transmitting the second response message.

In some embodiments, further comprising: exiting the guidance mode under a condition that a guidance ending instruction transmitted by the charging pile is received.

According to a sixth aspect of an embodiment of the present disclosure, there is provided a robot control device comprising: a mode converting module configured to detect whether the robot is currently in a preset guidance area in the process of approaching a charging pile, and enter a guidance mode under a condition that the robot is currently in the preset guidance area; a guidance requesting module configured to transmit a guidance request message to the charging pile, thereby a third positioning circuit transmitting a first response message to the charging pile after receiving a first request transmitted by the charging pile, and transmitting a second response message to the charging pile after receiving a second request transmitted by the charging pile; a path adjusting module configured to adjust a path according to a position after receiving information about the position transmitted by the charging pile; and a driving module configured to drive a moving mechanism according to the path, thereby the robot docking to the charging pile.

According to a seventh aspect of the embodiments of the present disclosure, there is provided a robot control device comprising: a processor; and a memory coupled to the processor, storing program instructions which, when executed by the processor, cause the processor to implement the control method according to any one of the embodiments described above.

According to an eighth aspect of the embodiments of the present disclosure, there is provided a robot comprising: a robot control device according to any one of the embodiments described above; a second communicating circuit configured to transmit a guidance request message transmitted by the robot control device to a charging pile, and transmit information about a position transmitted by the charging pile to the robot control device; a third positioning circuit configured to transmit a first response message to the charging pile after receiving a first request transmitted by the charging pile, and transmit a second response message to the charging pile after receiving a second request transmitted by the charging pile; and a moving mechanism configured to drive the robot to move according to a path provided by the robot control device.

According to a ninth aspect of the embodiments of the present disclosure, there is provided a non-transitory computer-readable storage medium, wherein the non-transitory computer readable storage medium stores computer instructions which, when executed by a processor, implement the control method according to any one of the embodiments described above.

Other features of the present disclosure and advantages thereof will become apparent from the following detailed description of exemplary embodiments thereof, which proceeds with reference to the accompanying drawings.

### BRIEF DESCRIPTION OF THE DRAWINGS

In order to more clearly illustrate the technical solutions in the embodiments of the present disclosure or the prior art, the drawings used in the embodiments or the description of the prior art will be briefly described below, it is obvious that the drawings in the following description are only some embodiments of the present disclosure, and for those skilled in the art, other drawings may be obtained according to the drawings without inventive labor.

FIG. 1 is a schematic flow diagram of a control method for providing guidance according to one embodiment of the present disclosure;

FIG. 2 is a schematic diagram of robot performing positioning according to one embodiment of the present disclosure;

FIG. 3 is a schematic structural diagram of a control device for providing guidance according to one embodiment of the present disclosure;

FIG. 4 is a schematic structural diagram of a control device for providing guidance according to another embodiment of the present disclosure;

FIG. 5 is a schematic structural diagram of a charging pile according to one embodiment of the present disclosure;

FIG. 6 is a flow chart illustrating a control device for providing guidance according to another embodiment of the present disclosure;

FIG. 7 is a schematic structural diagram of a robot control device according to one embodiment of the present disclosure;

FIG. 8 is a schematic structural diagram of a robot control device according to another embodiment of the present disclosure;

FIG. 9 is a schematic structural diagram of a robot according to one embodiment of the present disclosure.

### DETAILED DESCRIPTION

The technical solutions in the embodiments of the present disclosure will be described clearly and completely with reference to the drawings in the embodiments of the present disclosure, and it is obvious that the embodiments described are only some, rather than all, of the embodiments of the present disclosure. The following description of at least one exemplary embodiment is merely illustrative in nature and is in no way intended to limit the disclosure, its application, or uses. All other embodiments, which can be derived by a person skilled in the art from the embodiments disclosed herein without inventive step, are intended to be within the scope of the present disclosure.

The relative arrangement of parts and steps, numerical expressions and numerical values set forth in these embodiments do not limit the scope of the present disclosure unless specifically stated otherwise.

Meanwhile, it should be understood that the sizes of the respective portions shown in the drawings are not drawn in an actual proportional relationship for the convenience of description.

Techniques, methods, and devices known to one of ordinary skill in the art may not be discussed in detail but are intended to be part of the specification where appropriate.

In all examples shown and discussed herein, any particular value should be construed as exemplary only and not as limiting. Thus, other examples of the exemplary embodiments may have different values.

It should be noted that similar reference numbers and letters refer to similar items in the following figures, and thus, once an item is defined in one figure, it need not be discussed further in subsequent figures.

The inventors found through research that in the related art, the robot cannot accurately determine the position of the charging pile in the process that the robot gets back to the pile, and consequently the robot fails to get back to the pile.

In view of the above, this disclosure provides a guidance control scheme, which can ensure that the robot gets back to the charging pile fast and accurately for charging.

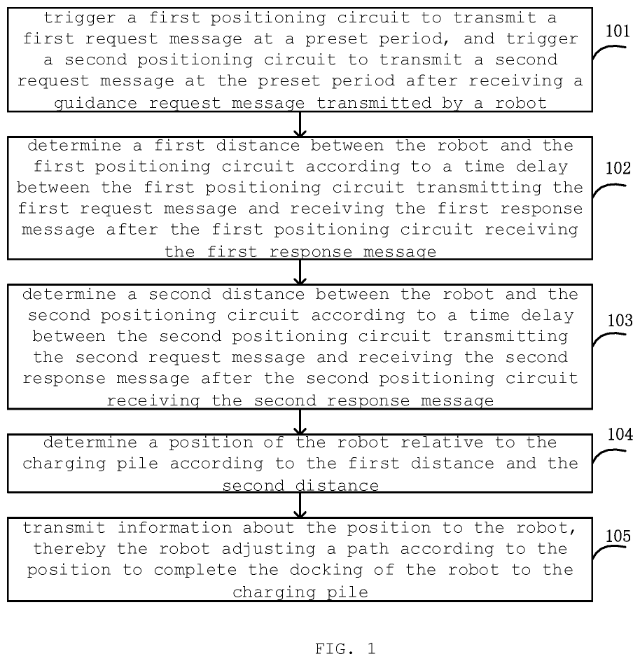

FIG. 1 is a flow diagram illustrating a control method for providing guidance according to one embodiment of the disclosure. In some embodiments, the following steps of the control method for providing guidance are performed by a control device for providing guidance in the charging pile.

In step 101, a first positioning circuit is triggered to transmit a first request message at a preset period, and a second positioning circuit is triggered to transmit a second request message at the preset period after a guidance request message transmitted by a robot is received, thereby the robot transmitting a first response message after receiving the first request message, and transmitting a second response message after receiving the second request message.

The robot detects whether the robot is currently in a preset guidance area in the process of approaching the charging pile. Under a condition that the robot is in the preset guidance area at present, the robot transmits a guidance request message to the charging pile.

In step 102, a first distance between the robot and the first positioning circuit is determined according to a time delay between the first positioning circuit transmitting the first request message and receiving the first response message after the first positioning circuit receiving the first response message.

In some embodiments, by extracting a first transmitting time at which the first request message is transmitted by the first positioning circuit and a first receiving time at which the first response message is received by the first positioning circuit, the first distance is calculated from a difference between the first receiving time and the first transmitting time.

For example, if the first transmitting time is Tb1 and the first receiving time is Tb2, the first distance R1 is R1=c×[Tb2−Tb1]/2, and c is the electromagnetic wave propagation speed.

In some embodiments, a second receiving time at which the robot receives the first request message and a second transmitting time at which the robot transmits the first response message are extracted from the first response message. Next, a first difference between the first receiving time and the first transmitting time and a second difference between the second transmitting time and the second receiving time are calculated, and the first distance is calculated based on a difference between the first difference and the second difference.

For example, if the first transmitting time is Tb1, the first receiving time is Tb2, the second receiving time is Tba1, and the second transmitting time is Tba2, therefore the first distance R1 is R1=c×[(Tb2−Tb1)−(Tba2−Tba1)]/2.

In step 103, a second distance between the robot and the second positioning circuit is determined according to a time delay between the second positioning circuit transmitting the second request message and receiving the second response message after the second positioning circuit receiving the second response message.

In some embodiments, by extracting a third transmitting time at which the second request message is transmitted by the second positioning circuit and a third receiving time at which the second response message is received by the second positioning circuit, the second distance is calculated from a difference between the third receiving time and the third transmitting time.

For example, if the third transmitting time is Tc1 and the third receiving time is Tc2, the second distance R2 is R2=c×[Tc2−Tc1]/2.

In some embodiments, a fourth receiving time at which the robot receives the second request message and a fourth transmitting time at which the robot transmits the second response message are extracted from the second response message. Next, by calculating a third difference between the third receiving time and the third transmitting time, and a fourth difference between the fourth transmitting time and the fourth receiving time, a second distance is calculated from a difference between the third difference and the fourth difference.

For example, if the third transmitting time is Tc1, the third receiving time is Tc2, the fourth receiving time is Tca1, and the fourth transmitting time is Tca2, therefore the second distance R2 is R2=c×[(Tc2−Tc1)−(Tca2−Tca1)]/2.

In step 104, a position of the robot relative to the charging pile is determined according to the first distance and the second distance.

In some embodiments, a first circular trajectory is determined by taking a position of the first positioning circuit as a circle center and a first distance as a radius, and a second circular trajectory is determined by taking a position of the second positioning circuit as a circle center and a second distance as a radius. An intersection point of the first circular trajectory and the second circular trajectory is taken as the position of the robot relative to the charging pile.

FIG. 2 is a schematic diagram of a robot performing positioning according to one embodiment of the present disclosure.

As shown in FIG. 2, the charging pile 21 is provided with a first positioning circuit 211 and a second positioning circuit 212. The robot 22 is provided with a third positioning circuit 221. According to the above processing, it can be determined that the distance between the robot 22 and the first positioning circuit 211 is R1 and the distance between the robot 22 and the second positioning circuit 212 is R2. The robot 22 is located on a circular trajectory C1 by taking the first positioning circuit 211 as a circle center and R1 as a radius, and also located on a circular trajectory C2 by taking the second positioning circuit 212 as a circle center and R2 as a radius. The relative position (X, Y) of the robot with respect to the charging pile can be determined by calculating the intersection point of the two circular trajectories using the following formula, in which the distance between the first positioning circuit 211 and the second positioning circuit 212 is 2 L.

X²+(Y−L)²=R1²

X²+(Y+L)²=R2²

At step 105, information about the position is transmitted to the robot, thereby the robot adjusting a path according to the position to complete the docking of the robot to the charging pile.

In the control method for providing guidance provided in the embodiments mentioned above of the disclosure, the charging pile interacts with the robot to determine the position of the robot relative to the charging pile, and the robot timely adjusts the path according to the position, to make sure that the robot returns to the charging pile quickly and accurately for charging.

In some embodiments, it is detected whether the signal receiver can receive the signal transmitted by the signal transmitter, wherein the signal receiver cannot receive the signal transmitted by the signal transmitter under a condition that the charging electrode of the robot is in contact with the charging electrode of the charging pile. If the signal receiver cannot receive the signal transmitted by the signal transmitter, which means that that the charging electrode of the robot is in contact with the charging electrode of the charging pile, in this case, the first positioning circuit is triggered to stop transmitting the first request message, and the second positioning circuit is triggered to stop transmitting the second request message, and a guidance ending instruction is transmitted to the robot.

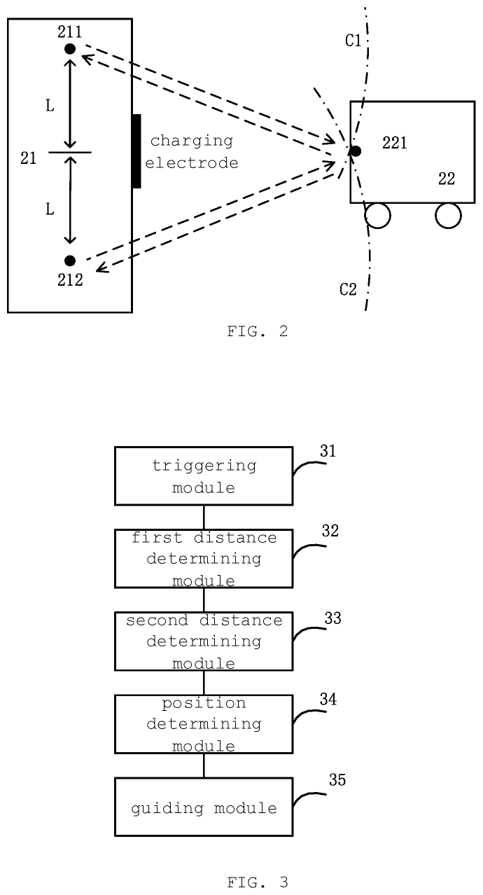

FIG. 3 is a schematic structural diagram of a control device for providing guidance according to one embodiment of the present disclosure. As shown in FIG. 3, the control device for providing guidance includes a triggering module 31, a first distance determining module 32, a second distance determining module 33, a position determining module 34, and a guiding module 35.

The triggering module 31 is configured to trigger a first positioning circuit to transmit a first request message at a preset period, and trigger a second positioning circuit to transmit a second request message at the preset period after receiving a guidance request message transmitted by a robot, thereby the robot transmitting a first response message after receiving the first request message, and transmitting a second response message after receiving the second request message.

The first distance determining module 32 is configured to determine a first distance between the robot and the first positioning circuit according to a time delay between the first positioning circuit transmitting the first request message and receiving the first response message after the first positioning circuit receiving the first response message.

In some embodiments, by extracting the first transmitting time at which the first request message is transmitted by the first positioning circuit and the first receiving time at which the first response message is received by the first positioning circuit, the first distance determining module 32 calculates the first distance based on a difference between a first receiving time and a first transmitting time.

In some embodiments, the first distance determining module 32 extracts a second receiving time when the robot receives the first request message and a second transmitting time when the robot transmits the first response message from the first response message. Next, a first difference between the first receiving time and the first transmitting time and a second difference between the second transmitting time and the second receiving time are calculated, and the first distance is calculated based on a difference between the first difference and the second difference.

The second distance determining module 33 is configured to determine a second distance between the robot and the second positioning circuit according to a time delay between the second positioning circuit transmitting the second request message and receiving the second response message after the second positioning circuit receiving the second response message.

In some embodiments, by extracting the third transmitting time at which the second request message is transmitted by the second positioning circuit and a third receiving time at which the second response message is received by the second positioning circuit, the second distance determining module 33 calculates the second distance according to a difference between a third receiving time and a third transmitting time.

In some embodiments, the second distance determining module 33 extracts a fourth receiving time at which the robot receives the second request message and a fourth transmitting time at which the robot transmits the second response message from the second response message. Next, by calculating a third difference between the third receiving time and the third transmitting time and a fourth difference between the fourth transmitting time and the fourth receiving time, a second distance is calculated from a difference between the third difference and the fourth difference.

A position determining module 34 is configured to determine a position of the robot relative to the charging pile according to the first distance and the second distance.

In some embodiments, the position determining module 34 determines a first circular trajectory by taking the position of the first positioning circuit as a circle center and the first distance as a radius, and determines the second circular trajectory by taking the position of the second positioning circuit as a circle center and the second distance as a radius. The intersection point of the first circular trajectory and the second circular trajectory is taken as the position of the robot relative to the charging pile.

A guiding module 35 is configured to transmit information about the position to the robot, thereby the robot adjusting a path according to the position to complete the docking of the robot to the charging pile.

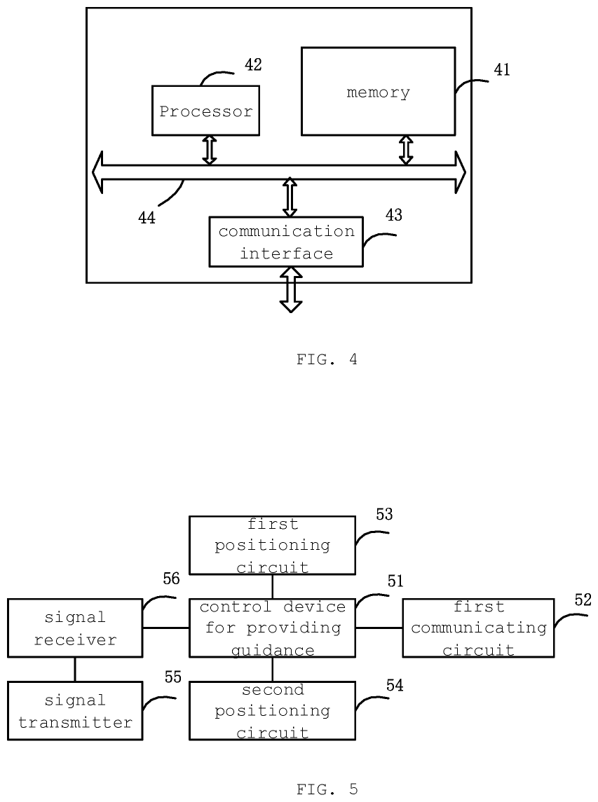

FIG. 4 is a schematic structural diagram of a control device for providing guidance according to another embodiment of the present disclosure. As shown in FIG. 4, the control device for providing guidance includes a memory 41 and a processor 42.

The memory 41 is used for storing instructions, and the processor 42 is coupled to the memory 41, and the processor 42 is configured to carry out the method according to any embodiment in FIG. 1 based on the instructions stored in the memory.

As shown in FIG. 4, the control device for providing guidance further includes a communication interface 43 for information interaction with other devices. Meanwhile, the control device for providing guidance further comprises a bus 44, and the processor 42, the communication interface 43 and the memory 41 are communicated with each other through the bus 44.

The memory 41 may comprise high-speed RAM memory, and may also include non-volatile memory, such as at least one disk memory. The memory 41 may also be a memory array. The memory 41 may also be partitioned into blocks, and the blocks may be combined into virtual volumes according to certain rules.

Further, the processor 42 may be a central processing unit (CPU), or may be an application specific integrated circuit (ASIC), or one or more integrated circuits configured to implement embodiments of the present disclosure.

The present disclosure also relates to a non-transitory computer-readable storage medium for storing computer instructions which, when executed by a processor, implement the method according to any one of the embodiments in FIG. 1.

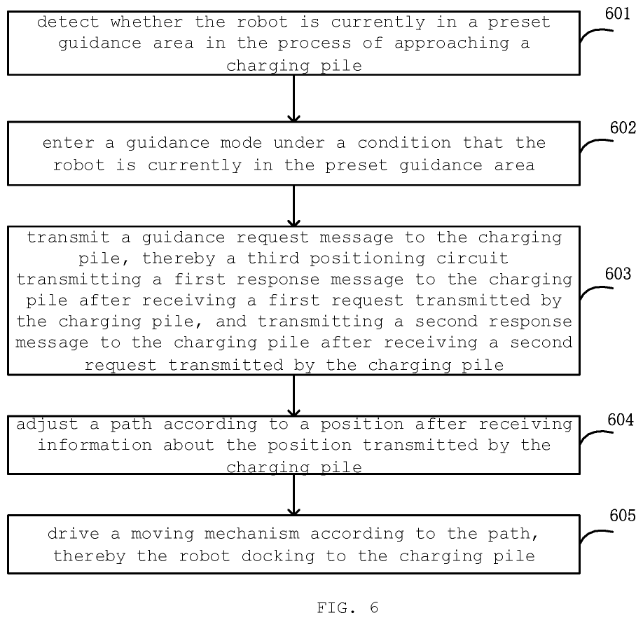

FIG. 5 is a schematic structural diagram of a charging pile according to an embodiment of the disclosure. As shown in FIG. 5, the charging pile includes a control device for providing guidance 51, a first communicating circuit 52, a first positioning circuit 53, and a second positioning circuit 54. The control device for providing guidance 51 is the control device for providing guidance according to any one of the embodiments of FIG. 3 or 4.

The first communicating circuit 52 is configured to transmit a guidance request transmitted by the robot to the control device for providing guidance 51, and also transmit information about the position determined by the control device for providing guidance 51 to the robot.

The first positioning circuit 53 is configured to transmit a first request message at a predetermined cycle according to a trigger instruction transmitted by the guidance control device 51, and receive a first response message transmitted by the robot upon receiving the first request message.

The second positioning circuit 54 is configured to transmit a second request message at a predetermined cycle according to a trigger instruction transmitted by the control device for providing guidance 51, and receive a second response message transmitted by the robot upon receiving the second request message.

In some embodiments, the first communicating circuit 52 communicates using a Lora communication technology, and the first positioning circuit 53 and the second positioning circuit 54 use a UWB (Ultra-Wide Band) communication technology.

In some embodiments, as shown in FIG. 5, the charging pile further includes a signal transmitter 55 and a signal receiver 56.

The signal receiver 56 is configured to receive the signal transmitted by the signal transmitter 55. Under a condition taht the charging electrode of the robot is in contact with the charging electrode of the charging pile, the signal receiver 56 cannot receive the signal transmitted by the signal transmitter 55.

In some embodiments, the signal transmitter 55 transmits an infrared signal and the signal receiver 56 receives an infrared signal.

In some embodiments, the first communicating circuit 52 is further configured to transmit the guidance ending instruction transmitted by the guidance control device 51 to the robot. The first positioning circuit 53 is also configured to stop transmitting the first request message according to a trigger instruction of the control device for providing guidance 51. The second positioning circuit 54 is further configured to stop transmitting the second request message according to a trigger instruction transmitted by the control device for providing guidance 51.

FIG. 6 is a flow diagram illustrating a control method for providing guidance according to another embodiment of the disclosure. In some embodiments, the following steps of the control method for providing guidance are performed by a robot control device in the robot.

In step 601, it is detected whether the robot is in a preset guidance area in the process that the robot approaches to the charging pile.

In step 602, a guidance mode is entered under a condition that the robot is currently in the preset guidance area.

In step 603, a guidance request message is transmitted to the charging pile, such that the third positioning circuit transmits a first response message to the charging pile after receiving a first request transmitted by the charging pile, and transmits a second response message to the charging pile after receiving the second request transmitted by the charging pile.

In some embodiments, the first response message comprises a time of the third positioning circuit for receiving the first request message and a time of the third positioning circuit for transmitting the first response message. The second response message comprises a time of the third positioning circuit for receiving the second request message and a time of the third positioning circuit for transmitting the second response message.

In step 604, a path is adjusted according to the position after information about the path transmitted by the charging pile is received.

In step 605, the moving mechanism is driven according to the adjusted path, such that the robot performs docking to the charging pile.

In some embodiments, the guidance mode is exited under a condition that a guidance ending instruction transmitted by the charging pile is received.

FIG. 7 is a schematic structural diagram of a robot control device according to one embodiment of the present disclosure. As shown in FIG. 7, the robot control device includes a mode converting module 71, a guidance requesting module 72, a path adjusting module 73, and a driving module 74.

The mode converting module 71 is configured to detect whether the robot is currently in a preset guidance area in the process of approaching a charging pile, and enter a guidance mode under a condition that the robot is currently in the preset guidance area.

The guidance request module 72 is configured to transmit a guidance request message to the charging pile, thereby a third positioning circuit transmitting a first response message to the charging pile after receiving a first request transmitted by the charging pile, and transmitting a second response message to the charging pile after receiving a second request transmitted by the charging pile.

In some embodiments, the first response message comprises a time of the third positioning circuit for receiving the first request message and a time of the third positioning circuit for transmitting the first response message. The second response message comprises a time of the third positioning circuit for receiving the second request message and a time of the third positioning circuit for transmitting the second response message.

The route adjusting module 73 is configured to adjust a path according to a position after receiving information about the position transmitted by the charging pile.

The drive module 74 is configured to drive a moving mechanism according to the path, thereby the robot docking to the charging pile.

In some embodiments, if the mode converting module 71 receives a guidance ending instruction transmitted by the charging pile, the mode converting module 71 exits the guidance mode.

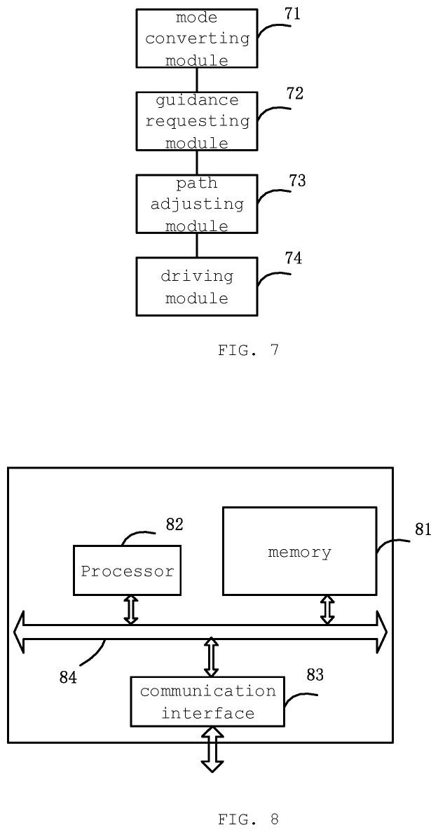

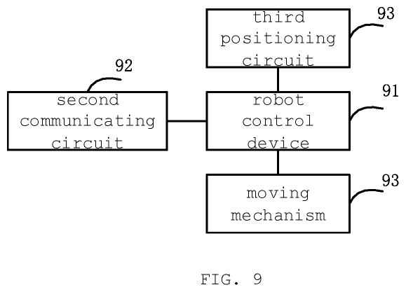

FIG. 8 is a schematic structural diagram of a robot control device according to another embodiment of the present disclosure. As shown in FIG. 8, the robot control device includes a memory 81, a processor 82, a communication interface 83, and a bus 84. FIG. 8 differs from FIG. 4 in that, in the embodiment shown in FIG. 8, the processor 82 is configured to perform the method in any of the embodiments of FIG. 6 based on instructions stored in the memory.

The present disclosure also relates to a non-transitory computer-readable storage medium storing computer instructions which, when executed by a processor, implement the method according to any one of the embodiments in FIG. 6.

FIG. 9 is a schematic structural diagram of a robot according to an embodiment of the present disclosure. As shown in FIG. 9, the robot includes a robot control device 91, a second communicating circuit 92, a third positioning circuit 93, and a moving mechanism 94. The robot control device 91 is the robot control device according to any one of the embodiments of FIGS. 7 and 8.

The second communicating circuit 92 is configured to transmit a guidance request message transmitted by the robot control device 91 to a charging pile, and transmit information about a position transmitted by the charging pile to the robot control device 91.

The third positioning circuit 93 is configured to transmit a first response message to the charging pile after receiving a first request transmitted by the charging pile, and transmit a second response message to the charging pile after receiving a second request transmitted by the charging pile.

In some embodiments, the first response message comprises a time of the third positioning circuit for receiving the first request message and a time of the third positioning circuit for transmitting the first response message. The second response message comprises a time of the third positioning circuit for receiving the second request message and a time of the third positioning circuit for transmitting the second response message.

In some embodiments, the second communicating circuit 92 adopts Lora communication technology for communicating, and the third positioning circuit 93 adopts UWB communication technology.

The moving mechanism 94 is configured to drive the robot to move according to a path provided by the robot control device.

In some embodiments, the functional unit modules described above can be implemented as a general purpose processor, a programmable logic controller (PLC), a digital signal processor (DSP), an application specific integrated circuit (ASIC), a field programmable gate array (FPGA) or other programmable logic device, discrete gate or transistor logic, discrete hardware components, or any suitable combination thereof for performing the functions described in this disclosure.

It will be understood by those skilled in the art that all or part of the steps for implementing the above embodiments may be implemented by hardware, or may be implemented by hardware related to instructions of a program, where the program may be stored in a non-transitory computer readable storage medium, and the storage medium may be a read-only memory, a magnetic disk or an optical disk.

The description of the present disclosure has been presented for purposes of illustration and description, and is not intended to be exhaustive or limited to the disclosure in the form disclosed. Many modifications and variations will be apparent to practitioners skilled in this art. The embodiment was chosen and described in order to best explain the principles of the disclosure and the practical application, and to enable others of ordinary skill in the art to understand the disclosure for various embodiments with various modifications as are suited to the particular use contemplated.

1. A control method for providing guidance performed by a control device for providing guidance in a charging pile, comprising:
triggering a first positioning circuit to transmit a first request message at a preset period, and triggering a second positioning circuit to transmit a second request message at the preset period after receiving a guidance request message transmitted by a robot, thereby the robot transmitting a first response message after receiving the first request message, and transmitting a second response message after receiving the second request message;
determining a first distance between the robot and the first positioning circuit according to a time delay between the first positioning circuit transmitting the first request message and receiving the first response message after the first positioning circuit receiving the first response message;
determining a second distance between the robot and the second positioning circuit according to a time delay between the second positioning circuit transmitting the second request message and receiving the second response message after the second positioning circuit receiving the second response message;
determining a position of the robot relative to the charging pile according to the first distance and the second distance; and
transmitting information about the position to the robot, thereby the robot adjusting a path according to the position to complete the docking of the robot to the charging pile.

2. The control method according to claim 1, further comprising:
detecting whether a signal receiver receive a signal transmitted by a signal transmitter, wherein the signal receiver cannot receive the signal transmitted by the signal transmitter under a condition that a charging electrode of the robot is in contact with a charging electrode of the charging pile; and
triggering the first positioning circuit to stop transmitting the first request message, and triggering the second positioning circuit to stop transmitting the second request message under a condition that the signal receiver cannot receive the signal transmitted by the signal transmitter, and transmitting a guidance ending instruction to the robot.

3. The control method according to claim 1, wherein the determining a first distance between the robot and the first positioning circuit comprises:
extracting a first transmitting time of the first positioning circuit for transmitting the first request message and a first receiving time of the first positioning circuit for receiving the first response message; and
calculating the first distance according to the difference between the first receiving time and the first transmitting time.

4. The control method according to claim 3, wherein the determining a first distance between the robot and the first positioning circuit further comprises:
extracting a second receiving time of the robot for receiving the first request message and a second transmitting time of the robot for transmitting the first response message from the first response message;
wherein the calculating the first distance comprises:
calculating a first difference between the first receiving time and the first transmitting time, and a second difference between the second transmitting time and the second receiving time; and
calculating the first distance according to a difference between the first difference and the second difference.

5. The control method according to claim 1, wherein the determining a second distance between the robot and the second positioning circuit comprises:
extracting a third transmitting time of the second positioning circuit for transmitting the second request message, and a third receiving time of the second positioning circuit for receiving the second response message; and
calculating the second distance according to a difference between the third receiving time and the third transmitting time.

6. The control method according to claim 5, wherein the determining a second distance between the robot and the second positioning circuit further comprises:
extracting a fourth receiving time of the robot for receiving the second request message and a fourth transmitting time of the robot for transmitting the second response message from the second response message;
wherein the calculating the second distance comprises:
calculating a third difference between the third receiving time and the third transmitting time, and a fourth difference between the fourth transmitting time and the fourth receiving time; and
calculating the second distance according to a difference between the third difference and the fourth difference.

7. The control method according to claim 1, wherein the determining a position of the robot relative to the charging pile according to the first distance and the second distance comprises:
determining a first circular trajectory by taking a position of the first positioning circuit as a circle center and the first distance as a radius;
determining a second circular trajectory by taking a position of the second positioning circuit as a circle center and the second distance as a radius; and
taking the intersection point of the first circular trajectory and the second circular trajectory as the position of the robot relative to the charging pile.

8. (canceled)

9. A control device for providing guidance, comprising:
a processor; and
a memory coupled to the processor, storing program instructions which, when executed by the processor, cause the processor to:
trigger a first positioning circuit to transmit a first request message at a preset period, and trigger a second positioning circuit to transmit a second request message at the preset period after receiving a guidance request message transmitted by a robot, thereby the robot transmitting a first response message after receiving the first request message, and transmitting a second response message after receiving the second request message;
determine a first distance between the robot and the first positioning circuit according to a time delay between the first positioning circuit transmitting the first request message and receiving the first response message after the first positioning circuit receiving the first response message;
determine a second distance between the robot and the second positioning circuit according to a time delay between the second positioning circuit transmitting the second request message and receiving the second response message after the second positioning circuit receiving the second response message;
determine a position of the robot relative to the charging pile according to the first distance and the second distance; and
transmit information about the position to the robot, thereby the robot adjusting a path according to the position to complete the docking of the robot to the charging pile.

10. A charging pile, comprising:
the control device for providing guidance according to claim 9;
a first communicating circuit configured to transmit a guidance request transmitted by a robot to the control device for providing guidance and transmit information about a position determined by the control device for providing guidance to the robot;
a first positioning circuit configured to transmit a first request message at a preset period according to a trigger instruction transmitted by the control device for providing guidance and receive a first response message transmitted by the robot upon receiving the first request message; and
a second positioning circuit configured to transmit a second request message at a preset period according to a trigger instruction transmitted by the control device for providing guidance, and receive the second response message transmitted by the robot upon receiving the second request message.

11. The charging pole according to claim 10, further comprising:
a signal transmitter;
a signal receiver configured to receive a signal transmitted by the signal transmitter, wherein the signal receiver cannot receive the signal transmitted by the signal transmitter under a condition that a charging electrode of the robot is in contact with a charging electrode of the charging pile.

12. The charging pole according to claim 11, wherein:
the first communicating circuit is further configured to transmit a guidance ending instruction transmitted by the guidance control device to the robot;
the first positioning circuit is further configured to stop transmitting the first request message according to a trigger instruction transmitted by the control device for providing guidance; and
the second positioning circuit is further configured to stop transmitting the second request message according to a trigger instruction transmitted by the control device for providing guidance.

13.-16. (canceled)

17. A robot control device, comprising:
a processor; and
a memory coupled to the processor, storing program instructions which, when executed by the processor, cause the processor to:
detect whether the robot is currently in a preset guidance area in the process of approaching a charging pile;
enter a guidance mode under a condition that the robot is currently in the preset guidance area;
transmit a guidance request message to the charging pile, thereby a third positioning circuit transmitting a first response message to the charging pile after receiving a first request transmitted by the charging pile, and transmitting a second response message to the charging pile after receiving a second request transmitted by the charging pile;
adjust a path according to a position after receiving information about the position transmitted by the charging pile; and
drive a moving mechanism according to the path, thereby the robot docking to the charging pile.

18. A robot, comprising:
a robot control device according to claim 17;
a second communicating circuit configured to transmit a guidance request message transmitted by the robot control device to a charging pile, and transmit information about a position transmitted by the charging pile to the robot control device;
a third positioning circuit configured to transmit a first response message to the charging pile after receiving a first request transmitted by the charging pile, and transmit a second response message to the charging pile after receiving a second request transmitted by the charging pile; and
a moving mechanism configured to drive the robot to move according to a path provided by the robot control device.

19. A non-transitory computer readable storage medium, wherein the non-transitory computer readable storage medium stores computer instructions which, when executed by a processor, implement the control method of claim 1.

20. The control device according to claim 9, wherein the processor is configured to:
detect whether a signal receiver receive a signal transmitted by a signal transmitter, wherein the signal receiver cannot receive the signal transmitted by the signal transmitter under a condition that a charging electrode of the robot is in contact with a charging electrode of the charging pile; and
trigger the first positioning circuit to stop transmitting the first request message, and triggering the second positioning circuit to stop transmitting the second request message under a condition that the signal receiver cannot receive the signal transmitted by the signal transmitter, and transmitting a guidance ending instruction to the robot.

21. The control device according to claim 9, wherein the processor is configured to:
extract a first transmitting time of the first positioning circuit for transmitting the first request message and a first receiving time of the first positioning circuit for receiving the first response message; and
calculate the first distance according to the difference between the first receiving time and the first transmitting time.

22. The control device according to claim 21, wherein the processor is configured to:
extract a second receiving time of the robot for receiving the first request message and a second transmitting time of the robot for transmitting the first response message from the first response message;
calculate a first difference between the first receiving time and the first transmitting time, and a second difference between the second transmitting time and the second receiving time; and
calculate the first distance according to a difference between the first difference and the second difference.

23. The control device according to claim 9, wherein the processor is configured to:
extract a third transmitting time of the second positioning circuit for transmitting the second request message, and a third receiving time of the second positioning circuit for receiving the second response message; and
calculate the second distance according to a difference between the third receiving time and the third transmitting time.

24. The control device according to claim 23, wherein the processor is configured to:
extract a fourth receiving time of the robot for receiving the second request message and a fourth transmitting time of the robot for transmitting the second response message from the second response message;
calculate a third difference between the third receiving time and the third transmitting time, and a fourth difference between the fourth transmitting time and the fourth receiving time; and
calculate the second distance according to a difference between the third difference and the fourth difference.

25. The robot control device according to claim 17, wherein:
the first response message comprises a time of the third positioning circuit for receiving the first request message and a time of the third positioning circuit for transmitting the first response message; and
the second response message comprises a time of the third positioning circuit for receiving the second request message and a time of the third positioning circuit for transmitting the second response message.
